(19) United States
(12) Patent Application Publication
(10) Pub. No.: US 2004/0114640 A1
(43) Pub. Date: Jun. 17, 2004

(54) System, method and device for aggregating SONET links

(76) Inventors: Nilesh M. Bhide, Hillsboro, OR (US); Linda Cline, Forest Grove, OR (US); Christian Maciocco, Tigard, OR (US); Srihari Makineni, Portland, OR (US); Manav Mishra, Hillsboro, OR (US)

Correspondence Address: BLAKELY SOKOLOFF TAYLOR & ZAFMAN, 12400 WILSHIRE BOULEVARD, SEVENTH FLOOR, LOS ANGELES, CA, 90025, US

(21) Appl. No.: 10/321,153

(22) Filed: Dec. 16, 2002

(51) Int. Cl. H04J 14/08

(52) U.S. Cl. 370/907

(57) ABSTRACT

Disclosed are a system and method of transmitting a data message from a first node to a second node in SONET frames over a plurality of aggregated SONET links. The data message may be partitioned into a plurality of message segments at the first node. At least some of the message segments may be encapsulated in SONET frames for transmission to the second node over the aggregated SONET links.

### BACKGROUND

1. Field

The subject matter disclosed herein relates to communication systems. In particular, the subject matter disclosed herein relates to communication between nodes in a communication system.

2. Information

Telecommunication data networks typically include a network backbone comprising fiber optic communication links coupling geographically dispersed nodes. Data is typically transmitted across such a network backbone according to the “Synchronous Optical NETwork” (SONET) protocol as indicated in a set of standards provided by the American National Standards Institute (ANSI T1.105.xx) or “Synchronous Digital Hierarchy” (SDH) protocol as indicated in a set of recommendations provided by the International Telecommunications Union (e.g., ITU-T G.707, G. 708, G.709, G.783 and G.784). Under the SONET/SDH protocol, a transmitting node may transmit data frames referred to as “SONET frames” to a destination node.

### BRIEF DESCRIPTION OF THE FIGURES

Non-limiting and non-exhaustive embodiments of the present invention will be described with reference to the following figures, wherein like reference numerals refer to like parts throughout the various figures unless otherwise specified.

FIG. 1 shows a schematic diagram of a system to transmit data in two or more physical bs according to a Synchronous Optical Network/Synchronous Digital Hierarchy (SONET/SDH) protocol according to an embodiment of the present invention.

FIG. 2 shows a diagram illustrating the transmission of message segments in multiple SONET/SDH links according to an embodiment of the system shown in FIG. 1b

FIG. 3 shows a schematic diagram of a system to transmit data between nodes in SONET/SDH data links according to an embodiment of the system shown in FIG. 1.

FIGS. 4 and 5 and show flow diagrams illustrating processes to dynamically provision an aggregation of SONET links for the transmission of message segments according to an embodiment of the system shown in FIG. 1.

FIG. 6 shows a format for a packetized link aggregation message according to an embodiment of the system shown in FIG. 3.

FIG. 7 shows a flow diagram illustrating a process to transmit message segments of a data message on a plurality of aggregated data links according to an embodiment.

FIG. 8 shows a flow diagram illustrating a process to recover a partitioned data message from packetized message segments received on a plurality of aggregated SONET links according to an embodiment.

FIG. 9 shows a format for a header portion of a packetized message segment for transmission in a SONET frame according to an embodiment of the processes shown in FIGS. 7 and 8.

### DETAILED DESCRIPTION

Reference throughout this specification to “one embodiment” or “an embodiment” means that a particular feature, structure, or characteristic described in connection with the embodiment is included in at least one embodiment of the present invention. Thus, the appearances of the phrase “in one embodiment” or “an embodiment” in various places throughout this specification are not necessarily all referring to the same embodiment. Furthermore, the particular features, structures, or characteristics may be combined in one or more embodiments.

“Machine-readable” instructions as referred to herein relate to expressions which may be understood by one or more machines for performing one or more logical operations. For example, machine-readable instructions may comprise instructions which are interpretable by a processor compiler for executing one or more operations on one or more data objects. However, this is merely an example of machine-readable instructions and embodiments of the present invention are not limited in this respect.

“Storage medium” as referred to herein relates to media capable of maintaining expressions which are perceivable by one or more machines. For example, a storage medium may comprise one or more storage devices for storing machine-readable instructions or data. Such storage devices may comprise storage media such as, for example, optical, magnetic or semiconductor storage media. However, this is merely an example of a storage medium and embodiments of the present invention are not limited in this respect.

“Logic” as referred to herein relates to structure for performing one or more logical operations. For example, logic may comprise circuitry which provides one or more output signals based upon one or more input signals. Such circuitry may comprise a finite state machine which receives a digital input and provides a digital output, or circuitry which provides one or more analog output signals in response to one or more analog input signals. Such circuitry may be provided in an application specific integrated circuit (ASIC) or field programmable gate array (FPGA). Also, logic may comprise machine-readable instructions stored in a memory in combination with processing circuitry to execute such machine-readable instructions. However, these are merely examples of structures which may provide logic and embodiments of the present invention are not limited in this respect.

“Synchronous Optical Network” (SONET) as referred to herein relates to a data transmission protocol according to a set of standards provided by the American National Standards Institute (ANSI T1.105.xx). “Synchronous Digital Hierarchy” (SDH) as referred to herein relates to a data transmission protocol according to a set of recommendations provided by the International Telecommunications Union (e.g., ITU-T G.707, G. 708, G.709, G.783 and G.784). “SONET/SDH” as referred to herein relates to aspects of either a SONET or SDH protocol, or both. Hereinafter, “SONET” and “SONET/SDH” may be applied interchangeably.

“Data frames” or “frames” as referred to herein relates to a segment of data which is formatted for transmission from a source to a destination. A data frame may comprise a header portion and a payload portion. A “SONET frame” as referred to herein relates to a data frame formatted for transmission according to a data transmission protocol such as SONET/SDH. However, these are merely examples of a data frame and SONET frame, and embodiments of the present invention are not limited in these respects.

A “node” as referred to herein relates to a physical location in a communication network. Nodes in a communication network may be coupled by one or more data links. A node may be associated with source or destination for data frames. However, these are merely examples of a node and embodiments of the present invention are not limited in these respects.

A “data path” as referred to herein relates to a logical communication conduit between nodes through which data frames may be transmitted at a given data rate. A physical data link between nodes in a network may provide a plurality of data paths between the nodes. For example, a physical data link may provide a plurality of data paths by interleaving data frames of respective data paths. However, these are merely examples of a data path and embodiments of the present invention are not limited in these respects.

A data path may be associated with a “mapping” of a service to a format of data frames transmitted in a physical data link. For example, a mapping may be associated with a particular mapping type or service type, data rate or transmission granularity. However, these are merely examples of attributes that may be associated with a mapping and embodiments of the present invention are not limited in these respects.

“Path terminating Equipment” (PTE) as referred to herein relates to equipment associated with a node for transmitting or receiving data in a data path. PTE may enable a mapping of a service to one or more data paths terminating at the PTE. However, this is merely an example of a PTE and embodiments of the present invention are not limited in this respect.

A “SONET link” as referred to herein relates to a data link to transmit SONET frames between nodes. For example, a SONET link may comprise an optical transmission medium coupled between a SONET framer at a transmitting node and a SONET framer at a receiving node. However, this is merely an example of a SONET link and embodiments of the present invention are not limited in these respects.

A “data message” as referred to herein relates to data that is to be transmitted from a source to a destination. For example, a data message may be addressed for transmission from a source application associated with a first node to a destination application associated with a destination node. However, this is merely an example of a data message and embodiments of the present invention are not limited in these respects.

A “message segment” as referred to herein relates to a portion of a data message that may be transmitted in a data link. For example, a data message may be partitioned into a plurality of message segments for transmission to a destination over a plurality of aggregated data links. However, this is merely an example of a message segment and embodiments of the present invention are not limited in these respects.

A “link aggregation message” as referred to herein relates to a message identifying two or more data links to be aggregated for the transmission of data between nodes. For example, a link aggregation message may identify two or more data links in an aggregated data link to enable a receiving node to reassemble a data message from message segments received on the two or more data links. However, this is merely an example of a link aggregation message and embodiments of the present invention are not limited in these respects.

Briefly, an embodiment of the present invention relates to a system and method of transmitting a data message from a first node to a second node in SONET frames over a plurality of aggregated SONET links. The data message may be partitioned into a plurality of message segments at the first node. At least some of the message segments may then be encapsulated in SONET frames for transmission to the second node over the aggregated SONET links. However, this is merely an example embodiment and other embodiments of the present invention are not limited in these respects.

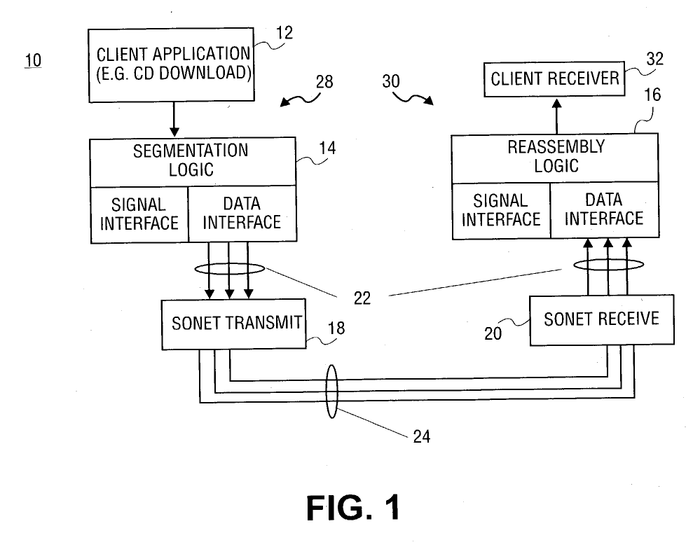

FIG. 1 shows a schematic diagram of a system 10 to transmit data in two or more physical SONET links 24 according to an embodiment of the present invention. A source node 28 and a destination node 30 are coupled between the SONET links 24 to transmit SONET data frames from the node 28 to the node 30. The SONET links 24 may comprise fiber optic cabling to transmit SONET data frames from a SONET transmit module 18 associated with the node 28 to a SONET receive module 20 associated with the node 30. For each SONET link 24, the SONET transmit and receive modules 18 and 20 may comprise a SONET transceiver/transponder device (not shown) for transmitting data to or receiving data from the SONET link 24.

The node 28 may comprise a data link controller 14 to receive a request to transmit a data message from a client application 12 to a client receiver 32. Segmentation logic of the data link controller 14 may receive the data message from the client application 12 and partition the data message into a plurality of message segments 22. A data interface of the data link controller 14 may then forward each message segment 22 to a SONET transmit module 18 for transmission to the node 30 on a SONET link 24 associated with the message segment 22.

The transmitted message segments 22 may then be received from a SONET receive module 20 at a data interface of data link controller 16. Reassembly logic of the data link controller 16 may then reassemble the received message segments to reconstruct the data message from the client application 12. Accordingly, the data link controllers 14 and 16 may transmit the data message in an aggregated SONET link comprising the plurality of data links 24.

According to an embodiment, the data link controllers 14 and 16 each comprise a signal interface to exchange control messages. For example, signal interfaces may enable a handshake protocol between the data link controllers 14 and 16 prior to the transmission of message segments 22 through aggregated SONET links 24. The signal interfaces may transmit or receive control messages which are encapsulated in SONET frames (e.g., SONET frames transmitted on any of the SONET links 24). Alternatively, the signal interfaces may transmit or receive control messages in an out-of-band data link. However, these are merely examples of how a control message may be transmitted between nodes in a SONET network and embodiments of the present invention are not limited in these respects.

SONET transmit module 18 and SONET receive module 20 may each comprise a plurality of SONET framers (not shown) where each SONET framer is coupled to a corresponding SONET link 24 to transmit SONET frames through or receive SONET frames from the SONET link 24. For example, the SONET transmit module 18 and SONET receive module 20 may each comprise four framers capable of transmitting or receiving SONET frames at a rate of OC-12. By aggregating four SONET links 24 coupled to the SONET framers, the aggregated SONET link may be capable of transmitting SONET frames at an effective rate of OC-48. In an other example, links 24 having idle transmission capacity may be aggregated to transmit data at a rate higher than would be possible over the available transmission capacity of a single link 24. However, these are merely examples of how SONET framers may be combined to achieve an effective SONET frame transmission rate higher than what is achievable with a single SONET framer and embodiments of the present invention are not limited in this respect.

According to an embodiment, each SONET link 24 may comprise one or more SONET lines coupled by line terminating equipment (LTE). Additionally, the SONET transmit module 18 and receive module 20 may each comprise PTE to define a data path in each of the SONET links 24. Accordingly, SONET frames transmitted in a SONET link 24 may be “mapped” to encapsulate message segments 22 according to any one of several communication protocols such as, for example, packet over SONET (POS), Asynchronous Transfer Mode (ATM), Ethernet over SONET (EOS) and Generic Framing Procedure (GFP). However, these are merely examples of types of mappings that may be applied in encapsulating message segments in a SONET path and embodiments of the present invention are not limited in these respects.

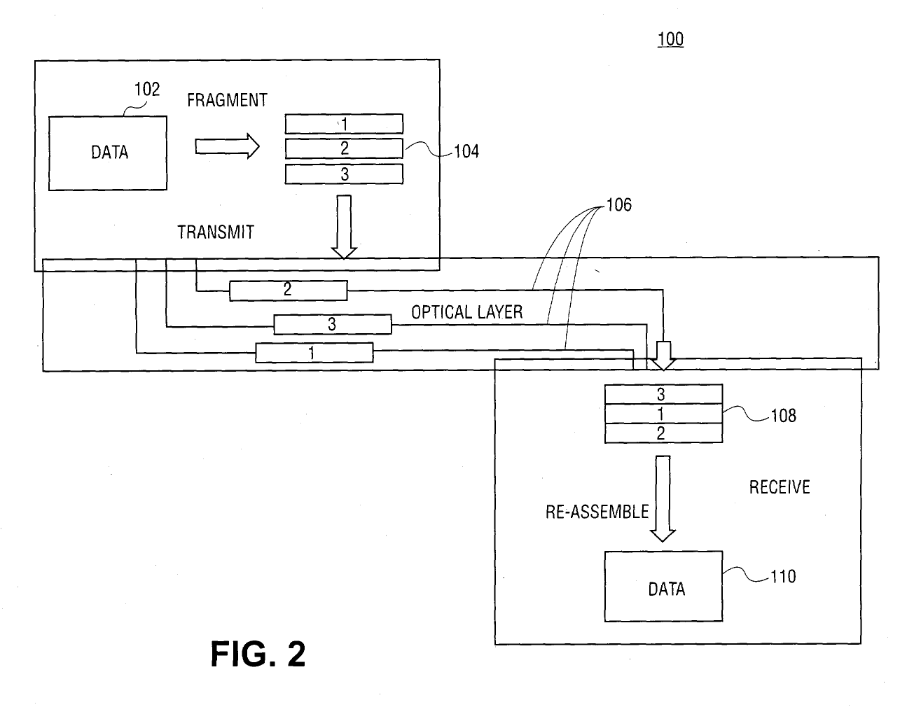

FIG. 2 shows a diagram illustrating the transmission of message segments in multiple SONET links according to an embodiment of the system shown in FIG. 1. A data message 102 may be partitioned into a sequence of ordered message segments 104 by segmentation logic at data link controller 14. Each message segment may then be transmitted on an optical transmission medium 106 that is distinct from the optical transmission media used to transmit the other message segments. While the transmitted message segments 104 may be ordered in a sequence, it should be understood that received message segments 108 may be received at SONET receive module 20 out of order. Reassembly logic at the data link controller 16 may reorder the received message segments 108 to provide a recovered data message 110 (which is equivalent to the original data message 102).

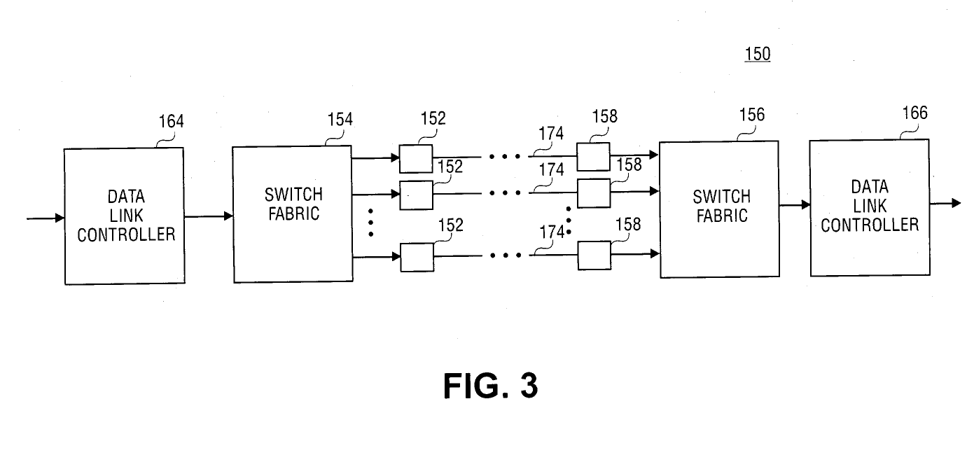

FIG. 3 shows a system 150 to transmit message segments in aggregated SONET links according to an embodiment of the system 10 shown in FIG. 1. A source data link controller 164 may initiate transmission of a data message to a destination data link controller 166 in message segments through a plurality of aggregated SONET links. Each SONET link may comprise an optical transmission medium 174 coupled between associated SONET framers 152 and 158. In addition to the data link controller 164, a transmitting node may comprise a multi-port switch fabric 154 to forward message segments to two or more SONET framers 152 associated with aggregated SONET links. Similarly, a receiving node comprises a multi-port switch fabric 156 to forward message segments received on SONET framers 158 the data link controller 166. The data link controller 166 may then reassemble received message segments to recover the data message.

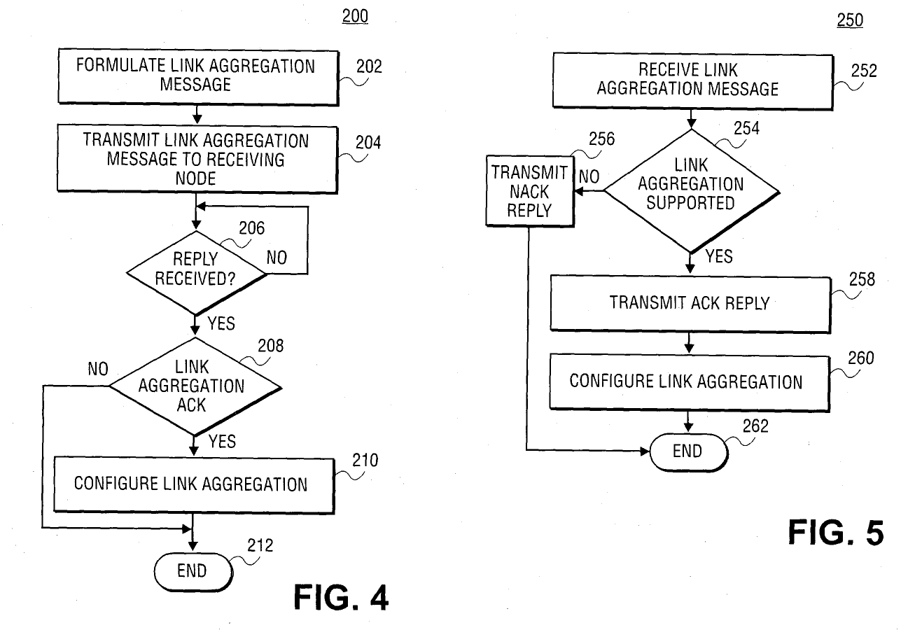

According to an embodiment, the data link controller 164 may provision the SONET links coupled between the switch fabrics 154 and 156 to support link aggregation using a static technique or dynamic messaging technique. Using the static technique, operators having access to setting the behavior of the data link controllers 164 and 166 may agree to enable link aggregation. Using the dynamic messaging technique, a transmitting node may transmit a link aggregation message to a receiving node to provision an aggregated SONET link between the transmitting and receiving nodes as illustrated in FIGS. 4 and 5.

FIGS. 4 shows a flow diagram illustrating a process 200 executed by a data link controller at a transmitting node to provision an aggregate link from two or more SONET links. FIG. 5 shows a flow diagram illustrating a process 250 executed by a data link controller at a receiving node in response to receipt of a link aggregation message from a transmitting node. A link aggregation message is formed at block 202 and transmitted to a receiving node at block 204. As discussed below, the link aggregation message may be encapsulated for transmission in a SONET frame to the receiving node or transmitted in an out-of-band data link.

The receiving node may receive the link aggregation message at block 252 and transmit a reply message either acknowledging that the requested link aggregation will be supported at (block 258) or indicating that the requested link aggregation will not be supported (at block 256). Like the link aggregation message, the reply message may be encapsulated for transmission in a SONET frame to the receiving node or in an out-of-band data link. If the requested link aggregation scheme is to be supported, the receiving node may be configured at block 260 to reassemble message segments received on aggregated links. Upon receipt of the reply message from the receiving node, the transmitting node may be configured for link aggregation at block 210 if the reply message from the receiving node indicates that link aggregation will be supported.

In alternative embodiments, a link aggregation message from a transmitting node may specify any one of a plurality of possible link aggregation schemes. Other than indicating that a specified scheme would not be supported, a reply message may specify one or more alternative schemes for aggregating links, allowing the transmitting node to select from among the alternative schemes. However, these are merely examples of how a link aggregation message (and a reply message to same) may be used to dynamically provision an aggregation of links between nodes in a SONET network, and embodiments of the present invention are not limited in these respects.

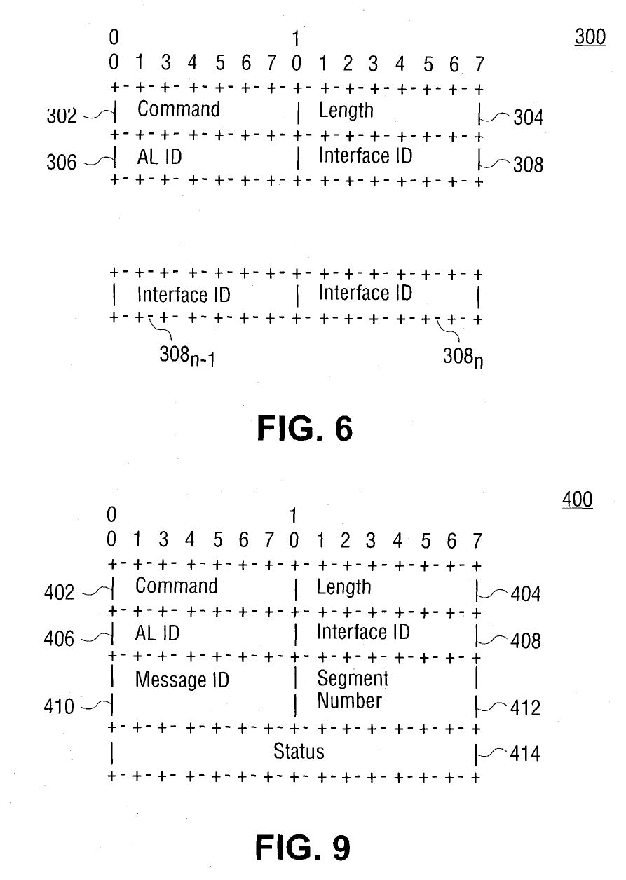

FIG. 6 shows a format for a packetized link aggregation message 300 according to an embodiment of the processes shown in FIGS. 4 and 5. Such a link aggregation message 300 may be transmitted from a first data link controller at block 204 to indicate a scheme to be used in provisioning an aggregation of links (or in a reply message specifying an alternative link aggregation scheme). The link aggregation message 300 may comprise a plurality of predefined fields. A one-byte command field 302 may identify the message as a link aggregation message. Each of a plurality of interface ID fields 308 may identify a physical data link (e.g., a SONET link 24) that is to be aggregated for transmitting a data message. An aggregate link identifier in field 306 may associate each of the SONET links identified in the fields 308 with an aggregate link. A length field 304 may indicate the length of the link aggregation message 300.

The link aggregation message 300 may be transmitted to a destination data link controller (e.g., at block 212) using any one of several in-band or out-of-band messaging techniques. In one in-band messaging technique, for example, the link aggregation message 300 may be encapsulated in a portion of a SONET Path Overhead (such as the “Z3” byte location) associated with the SONET path. In this approach, the link aggregation message 300 may be transmitted to the receiving node in a series of SONET frames, one byte in each SONET frame. In another in-band messaging technique, the link aggregation message 300 may be encapsulated in a portion of a Data Communication Channel (DCC) of a SONET Section or Line Overhead of a SONET frame (e.g., transmitted in one of the aggregated SONET links).

Using either of the aforementioned in-band messaging techniques, the link aggregation message 300 may also be encapsulated in a data link frame according to a link-level protocol such as the High-level Data Link Control (HDLC) protocol. Upon receipt of the data link frame, the data link frame may be processed for message detection and verification to receive the link aggregation message 300. A data link controller at a receiving node may then use the information in the link aggregation message 300 to reassemble received message segments according to recover the partitioned data message.

In an alternative to encapsulating the link aggregation message 300 in as an in-band message, the link aggregation message 300 may be encapsulated in an out-of-band message. For example, the link aggregation message may be transmitted between a data link controller at transmitting node to a data link controller at a receiving node in an out-of-band message according to a Link Management Protocol or RSVP-TE protocol. For example, the data link controller at transmitting node to a data link controller at a receiving node may be coupled to an Ethernet connection to transmit the link aggregation message and reply message. However, this is merely an example of how a link aggregation message (and reply message to same) may be transmitted between data link controllers in an out-of-band message and embodiments of the present invention are not limited in these respects.

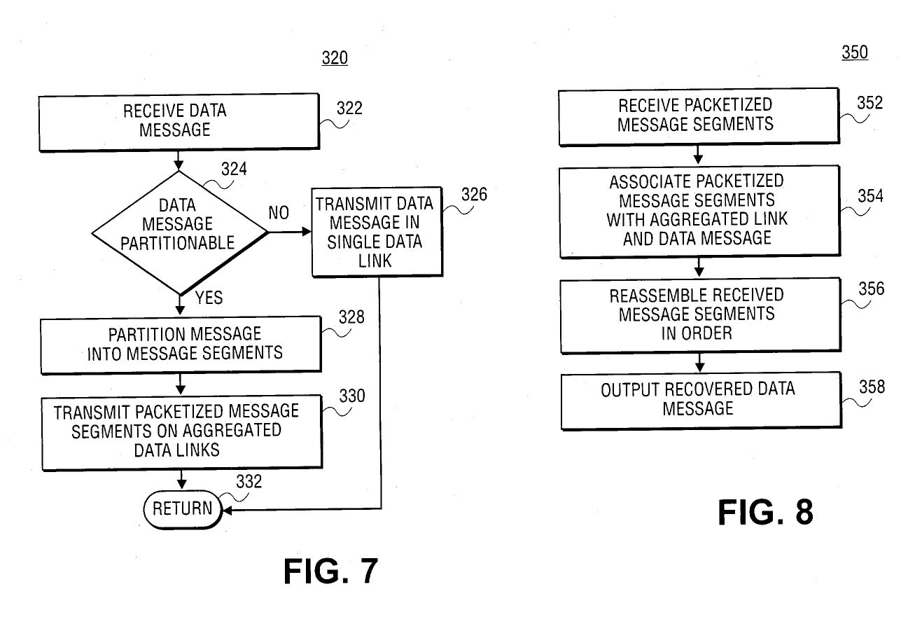

FIG. 7 shows a flow diagram illustrating a process 320 to initiate transmission of message segments in aggregated SONET links from a transmitting node according to an embodiment of the system shown in FIG. 1. FIG. 8 shows a flow diagram illustrating a process 350 to receive and reassemble message segments in aggregated SONET links at a receiving node according to an embodiment of the system shown in FIG. 1. According to an embodiment, the processes 320 and 350 may be executed following of a provisioning of an aggregation of links between the transmitting and receiving nodes. For example, the transmitting and receiving nodes may be configured to transmit message segments over a plurality of predefined SONET links aggregated to form an aggregated SONET link (e.g., as provide in a link aggregation message formatted as shown in FIG. 6).

Either process 320 or 350 may be executed or controlled by logic in a data link controller (e.g., in the data link controller 14 for the process 320 or the data link controller 16 for the process 350). For example, a data link controller may comprise a programmable processor core that executes the process 320 or 350 according to machine-readable instructions stored in a storage medium. Alternatively, the data link controller may comprise an ASIC or FPGA to execute the process 320 or 350. However, these are merely examples of logic that may be implemented in a data link controller and embodiments of the present invention are not limited in these respects.

A data message may be received from a client application at block 322. Diamond 324 may determine whether the data message may be partitioned into message segments for transmission over two or more aggregated SONET links. A data message may not be partitioned under certain conditions such as, for example, the data message originates from an input port that is subject to a policy that forbids data traffic from the port from being partitioned. Such a policy may be communicated to the process 320 by, for example, an updatable data structure of configuration information associated with the transmitting node. However, these are merely examples of data messages that may not be partitioned into message segments for transmission over two or more aggregated SONET links and embodiments of the present invention are not limited in these respects.

If the received data message is not partitionable into message segments for transmission over two or more aggregated SONET links, block 326 may initiate transmission of the-data message through a single SONET link (e.g., through a single SONET framer). If the received data message is partitionable, block 328 may partition the received into plurality of message segments for transmission over a plurality of aggregated SONET links. Block 330 may then initiate the transmission of the message segments on the aggregated SONET links. For example, each of the message segments may be encapsulated or packetized in a payload portion of a SONET frame to be transmitted in one of the aggregated SONET links.

In response to receipt of the packetized message segments at block 352, at block 354 the receiving node may associate the packetized message segments with the aggregated link, and the partitioned data message. Received message segments associated with the partitioned data message may then be reassembled at block 356 and the recovered data message may be output at block 358.

FIG. 9 shows a format for a header portion 400 of a message segment packet for transmission of a message segment in a payload portion of a SONET frame according to an embodiment of the process shown in FIG. 4 or 5. For example, the header portion 400 may be appended to a payload portion comprising an encapsulated message segment transmitted at block 330 or received at block 352. Each packetized message segment transmitted in an aggregated SONET link (e.g., a SONET link identified in a field 308 of a preceding link aggregation message 300 used in provisioning the aggregated SONET link) may comprise a header 400 to enable a receiving SONET link controller to reassemble a data message from encapsulated message segments (e.g., at block 356). The header portion 400 may comprise a command field to identify the payload portion as comprising an encapsulated message segment. Field 406 may comprise an aggregated SONET link identifier that is associated with a provisioned aggregated SONET link. The aggregated SONET link identifier may match an aggregated SONET link identifier provided in a previously received link aggregation message (e.g., a SONET link identifier in field 306 of link aggregation message 300). A message identifier field 410 may also associate the message segment with a particular data message transmitted in the identified aggregated SONET link. Based upon information in fields 406 and 410, a data link controller may associate message segments received on different SONET links with a single data message (e.g., a data message previously partitioned into message segments).

According to an embodiment, message segments from a partitioned data message (e.g., partitioned at block 328) may be ordered in a sequence from first to last. Each message segment may be associated with a position in the ordered sequence. The header portion 400 appended to an encapsulated message segment may also comprise a segment number in a field 412 indicating a position of the message segment among the ordered message segments making up the partitioned data message. In addition to associating message segments from different SONET links with a data message (e.g., by associating received message segments with the data message based on the aggregated link identifier in field 406 and the message identifier in field 410), a data link controller may also reassemble the data message from the received message segments based upon the segment number in field 412 (e.g., at block 356). For example, the payload portions of respective message segment packets (containing encapsulated message segments) may be concatenated in an order according to the appended segment numbers.

Following provisioning of link aggregation among a plurality of SONET links between transmitting and receiving nodes, one of the SONET links may transmit a mixture of message segments from partitioned data messages (to be transmitted over the aggregated links) and data from non-segmented data messages (i.e., not partitioned for transmission of over the aggregated SONET links). In one embodiment, the transmitting node may merely packetize message segments and data from non-segmented data messages as illustrated above with reference to FIG. 9. For frames transmitting data from non-segmented data messages, the command field 402 may be used to indicate that the appended data is from a non-segmented message.

In an alternative to packetizing the data from non-segmented data messages (as illustrated in FIG. 9), a transmitting node may place information in a portion of overhead in SONET frames to indicate that data from non-segmented data messages are being transmitted. For example, the transmitting node may place a marker in a Z3 byte of a SONET Path Overhead portion to indicate transitions between the transmission of packetized message segments and data from non-segmented data messages.

While there has been illustrated and described what are presently considered to be example embodiments of the present invention, it will be understood by those skilled in the art that various other modifications may be made, and equivalents may be substituted, without departing from the true scope of the invention. Additionally, many modifications may be made to adapt a particular situation to the teachings of the present invention without departing from the central inventive concept described herein. Therefore, it is intended that the present invention not be limited to the particular embodiments disclosed, but that the invention include all embodiments falling within the scope of the appended claims.

What is claimed is:

1. A system comprising:
a switch fabric comprising a plurality of ports;
a plurality of SONET framers, each SONET framer being coupled to a port of the switch fabric; and
a data link controller comprising:
logic to partition a data message into a plurality of message segments; and
logic to forward two or more of the message segments through the switch fabric to each of at least two of the SONET framers for transmission in a plurality of SONET links coupled to the SONET framers.

2. The system of claim 1, wherein each of the at least two of the SONET framers comprises logic to encapsulate a message segment received from the switch fabric in a SONET frame for transmission in a SONET link coupled to the SONET framer.

3. The system of claim 1, wherein the data link controller further comprises logic to transmit a link aggregation message to a receiving node, the link aggregation message identifying two more SONET links in an aggregated SONET link.

4. The system of claim 3, wherein the data link controller further comprises logic to append information to each message segment associated with the aggregated SONET link.

5. A system comprising:
a switch fabric comprising a plurality of ports;
a plurality of SONET framers, each SONET framer being adapted to forward at least a portion of SONET frames received from a SONET link through a port of the switch fabric; and
a data link controller comprising:
logic to receive from the switch fabric message segments encapsulated in portions of received SONET frames;
logic to reassemble a data message from a plurality of message segments, the message segments being received in SONET frames from a plurality of SONET links.

6. The system of claim 5, wherein the data link controller further comprises:
logic to receive a link aggregation message from a transmitting node, the link aggregation message identifying two more SONET links in an aggregated SONET link; and
logic to associate each of the message segments with the aggregated SONET link based upon information appended to the message segment.

7. The system of claim 6, wherein the logic to reassemble the data message from message segments further comprises logic to concatenate message segments associated with the aggregated SONET link in an ordered sequence of message segments based upon segment numbers appended to the message segments.

8. A method comprising:
partitioning a data message into a plurality of message segments at a first node;
encapsulating at least some of the message segments in a plurality of SONET frames; and
transmitting the SONET frames to a second node over a plurality of SONET links.

9. The method of claim 8, the method further comprising:
receiving the SONET frames at the second node; and
reassembling the data message from message segments in the received SONET frames.

10. The method of claim 9, wherein reassembling the message from message segments in the received SONET data frames further comprises:
associating at least some of the message segments in the received SONET frames with an aggregate link identifier; and
concatenating at least portion of each message segment associated with the aggregate link identifier.

11. The method of claim 10, the method further comprising
transmitting a link aggregation message from the first node to the second node, the link aggregation message comprising information identifying the SONET links transmitting the message segments.

12. The method of claim 11, wherein transmitting the link aggregation message further comprises:
encapsulating the link aggregation message in a data communication channel portion of one or more SONET frames at the first node;
transmitting the SONET frames to the second node.

13. The method of claim 11, wherein transmitting the link aggregation message further comprises transmitting the link aggregation message to the second node independently of transmission of SONET frames to the second node.

14. The method of claim 8, wherein transmitting the SONET frames to the second node further comprises:
associating each SONET frame with a data path coupled between path terminating equipment (PTE) associated with the first node and PTE associated with the second node; and
transmitting the SONET frame in the associated data path.

15. The method of claim 8, wherein partitioning the data message into a plurality of message segments further comprises partitioning the data message into an ordered sequence of message segments, and wherein the method further comprises associating each message segment with a position in the ordered sequence.

16. The method of claim 15, the method further comprising appending a segment number to each of the encapsulated message segments, the segment number being associated with the position of the encapsulated message segment in the ordered sequence of message segments.

17. The method of claim 16, the method further comprising:
receiving each of the transmitted SONET frames at the second node; and
reassembling the data message from message segments encapsulated in the received SONET frames based upon segment numbers appended to the encapsulated message segments.

18. A data link controller comprising:
logic to partition a data message into a plurality of message segments;
and
logic to forward at least one of the message segments to each of at least two SONET framers for transmission in a plurality of SONET links coupled to the SONET framers.

19. The data link controller of claim 18, wherein each of the at least two of the SONET framers comprises logic to encapsulate the at least one message segment in a SONET frame for transmission in a SONET link coupled to the SONET framer.

20. The data link controller of claim 19, wherein the data link controller further comprises logic to transmit a link aggregation message to a receiving node, the link aggregation message identifying two more SONET links in an aggregated SONET link.

21. The data link controller of claim 20, wherein the data link controller further comprises logic to append information to each message segment associated with the aggregated SONET link.

22. The data link controller of claim 20, wherein the data link controller further comprises logic to encapsulate the link aggregation message in a data communication channel portion of one or more SONET frames.

23. The data link controller of claim 20, wherein the data link controller further comprises logic to transmit the link aggregation message independently of transmission of SONET frames.

24. The data link controller of claim 18, wherein the logic to partition the data message into a plurality of message segments further comprises:
logic to partition the data message into an ordered sequence of message segments; and
logic to associate each message segment with a position in the ordered sequence.

25. The data link controller of claim 24, the data link controller further comprising logic to append a segment number to each message segment, the segment number being associated with the position of the message segment in the ordered sequence of message segments.

26. A data link controller comprising:
logic to receive message segments encapsulated in portions of SONET frames from a plurality of SONET links; and
logic to reassemble a data message from the received message segments.

27. The data link controller of claim 26, wherein the data link controller further comprises:
logic to receive a link aggregation message from a transmitting node, the link aggregation message identifying two more SONET links in an aggregated SONET link; and
logic to associate at least some of the received message segment with the aggregated SONET link based upon information appended to the at least some of the message segments.

28. The data link controller of claim 27, wherein the logic to reassemble the data message from received message segments further comprises logic to concatenate message segments associated with the aggregated SONET link in an ordered sequence of message segments based upon segment numbers appended to the message segments.

29. An article comprising:
a storage medium comprising machine-readable instructions stored thereon to:
partition a data message into a plurality of message segments; and
forward at least one of the message segments to each of at least two SONET framers for transmission in a plurality of SONET links coupled to the SONET framers.

30. The article of claim 29, wherein the storage medium further comprises machine-readable instructions stored thereon to encapsulate the at least one message segment in a SONET frame for transmission in a SONET link coupled to a SONET framer.

31. The article of claim 29, wherein the storage medium further comprises machine-readable instructions stored thereon to initiate transmission of a link aggregation message to a receiving node, the link aggregation message identifying two more SONET links in an aggregated SONET link.

32. The article of claim 31, wherein the storage medium further comprises machine-readable instructions stored thereon to append information associated with the aggregated SONET link to at least some of the message segments.

33. The article of claim 31, wherein the storage medium further comprises machine-readable instructions stored thereon to encapsulate the link aggregation message in a data communication channel portion of one or more SONET frames.

34. The article of claim 20, wherein the storage medium further comprises machine-readable instructions stored thereon to initiate transmission of the link aggregation message independently of transmission of SONET frames.

35. The article of claim 29, wherein the storage medium further comprises machine-readable instructions stored thereon to:
partition the data message into an ordered sequence of message segments; and
associate each message segment with a position in the ordered sequence.

36. The article of claim 29, wherein the storage medium further comprises machine-readable instructions stored thereon to append a segment number to each message segment, the segment number being associated with the position of the message segment in the ordered sequence of message segments.

37. An article comprising:
a storage medium comprising machine-readable instructions stored thereon to:
receive message segments encapsulated in portions of SONET frames from a plurality of SONET links; and
reassemble a data message from the received message segments.

38. The article of claim 37, wherein the storage medium further comprises machine-readable instructions stored thereon to:
receive a link aggregation message from a transmitting node, the link aggregation message identifying two more SONET links in an aggregated SONET link; and
associate at least some of the received message segments with the aggregated SONET link based upon information appended to the message segments.

39. The article of claim 37, wherein the storage medium further comprises machine-readable instructions stored thereon to concatenate message segments associated with the aggregated SONET link in an ordered sequence of message segments based upon segment numbers appended to the message segments.
